(19) United States
(12) Patent Application Publication
(10) Pub. No.: US 2021/0039948 A1
(43) Pub. Date: Feb. 11, 2021

(54) OZONE GENERATOR

(71) Applicants: KABUSHIKI KAISHA TOSHIBA, Minato-ku (JP); TOSHIBA INFRASTRUCTURE SYSTEMS & SOLUTIONS CORPORATION, Kawasaki-shi (JP)

(72) Inventors: Michiko HASHIMOTO, Atsugi (JP); Takaaki MURATA, Kawasaki (JP); Kie KUBO, Toshima (JP); Yuji OKITA, Kawasaki (JP)

(73) Assignees: KABUSHIKI KAISHA TOSHIBA, Minato-ku (JP); TOSHIBA INFRASTRUCTURE SYSTEMS & SOLUTIONS CORPORATION, Kawasaki-shi (JP)

(21) Appl. No.: 16/963,445

(22) PCT Filed: Sep. 13, 2018
(86) PCT No.: PCT/JP2018/033931

§ 371 Date: Jul. 20, 2020

(30) Foreign Application Priority Data
Jan. 30, 2018 (JP) 2018-013793

(51) Int. Cl. C01B 13/11

(52) U.S. Cl. CPC C01B 13/11; C01B 2201/20; C01B 2201/14

(57) ABSTRACT

An ozone generator includes a metal electrode, a dielectric element, a conductive film, and a power feeding member. The dielectric element has a tubular shape and is spaced from the metal electrode with a discharge gap to which raw gas is supplied. The conductive film is located. on an inner surface of the dielectric element. The power feeding member is electrically connected to the conductive film, and includes a contact member of a mesh form including a plurality of woven metal wires. The contact member contacts with the conductive film.

### FIELD

Embodiments described herein relate generally to an ozone generator.

### BACKGROUND

Ozone generators that generate ozone are known. For example, an ozone generator applies a voltage to a space between electrodes opposing across a dielectric, to generate silent discharge at a discharge gap between the electrodes. Thereby, the ozone generator generates ozone from raw oxygen-containing gas supplied to the discharge gap. Such an ozone generator includes a power feeding member that applies a high voltage to one of the electrodes from an exterior power supply.

### CITATION LIST

### Patent Literature

Patent Literature 1: Japanese Laid-open. Patent Application. Publication No, 2011-37689

Patent. Literature 2: International Publication. No. WO2015/122132

Patent Literature 3: Japanese Laid-open Patent Application. Publication No, 2013-184874

Patent Literature 4: Japanese Laid-open Patent Application Publication No. H11-199208

Patent Literature 5: Japanese Laid-open Patent Application Publication No. 2004-59365

Patent Literature 6: Japanese Laid-open Patent Application Publication No. 2009-34674

### SUMMARY OF THE INVENTION

### PROBLEM TO BE SOLVED BY THE INVENTION

However, the power feeding member of the ozone generator as above may be damaged if a high current flows through the power feeding member. A highly durable power feeding member is thus desirable.

### MEANS FOR SOLVING PROBLEM

In view of the above problem and attaining an object, an ozone generator includes a metal electrode, a dielectric element, a conductive and a power feeding member. The dielectric element has a tubular shape and is spaced from the metal electrode with a discharge gap to which raw gas is supplied. The conductive film is located. on an inner surface of the dielectric element. The power feeding member is electrically connected to the conductive film, and includes a contact member of a mesh form including a plurality of woven metal wires. The contact member contacts with the conductive film.

### BRIEF DESCRIPTION OF DRAWINGS

FIG. 1 is a section view illustrating the overall configuration of an ozone generator according to a first embodiment;

FIG. 2 is an enlarged section view of the vicinity of a dielectric electrode according to the first embodiment.

FIG. 3 is a side view of a power feeding member according to the first embodiment;

FIG. 4 is a section view of the power feeding member along a IV-IV line;

FIG. 5 is an overall perspective view of an elastic member of the power feeding member;

FIG. 6 is a side view of the elastic member.

FIG. 7 a side view of a contact member of the power feeding member;

FIG. 8 is a section view of a power feeding member according to a second embodiment; and

FIG. 9 is a section view of a power feeding member according to a third embodiment.

### DETAILED DESCRIPTION

The following exemplary embodiments and modifications include same or like elements. Hereinafter, the same or like elements are denoted by the same reference numerals, and redundant descriptions are partially omitted. Part of one embodiment or modification can be replaced by the corresponding part of another embodiment or modification. Moreover, the configurations and locations or positions of parts of one embodiment or modification are the same as in another embodiment or modification unless otherwise mentioned.

### First Embodiment

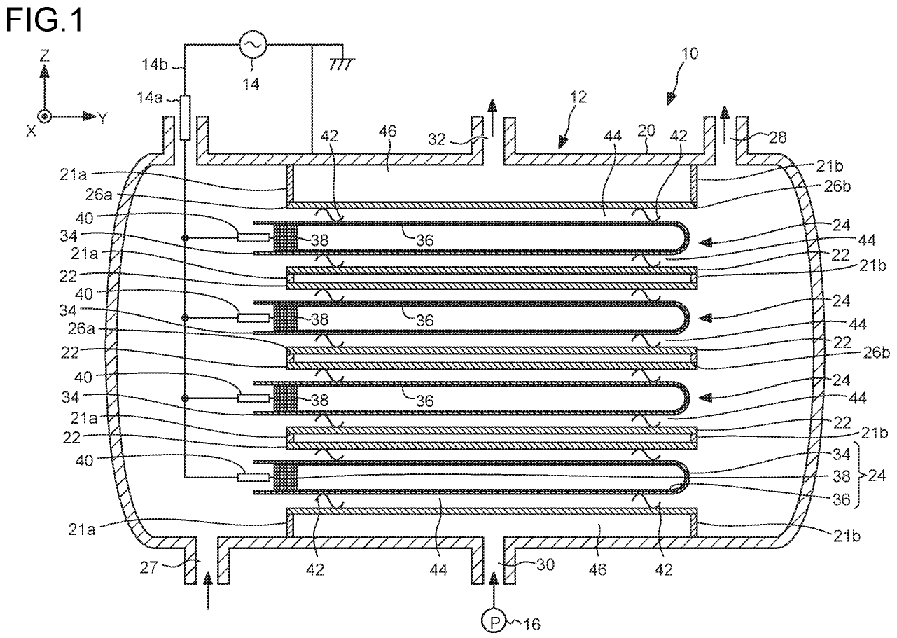

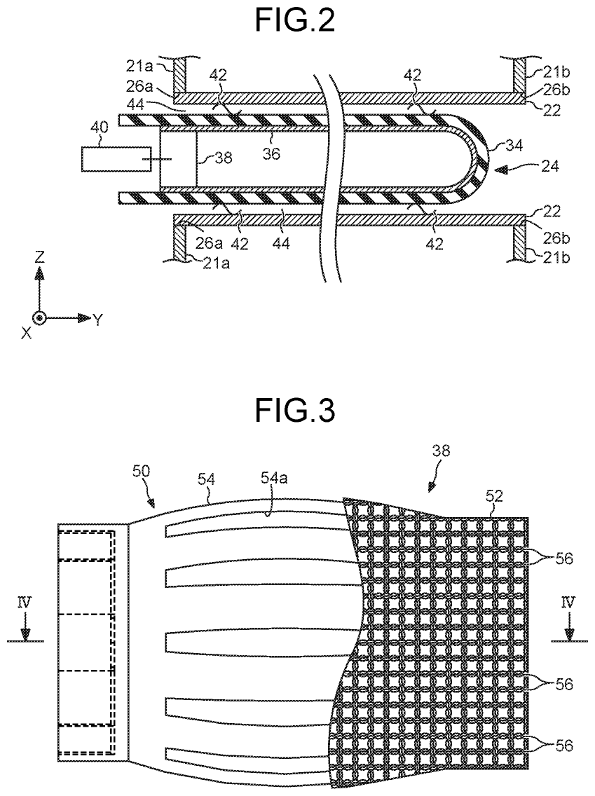

FIG. 1 is a section view illustrating the overall configuration of an ozone generator 10 according to a first embodiment. FIG. 2 is an enlarged section view of the vicinity of a dielectric electrode 24 according to the first embodiment. The directions indicated by the arrows of X axis, Y axis, and Z axis illustrated in FIG. 1 are defined as an X direction, a Y direction, and a Z direction, respectively. As illustrated in FIG. 1 and. FIG. 2, the ozone generator 10 includes a device body 12, a high-voltage power supply 14, and a cooling-water supplier 16.

The device body 12 includes an airtight container 20, a pair of end plates 21a, 21b, a plurality of metal electrodes 22, a plurality of dielectric electrodes 24, fuses 40, and spacers 42.

The airtight container 20 has a hollow tubular shape with an axis extending in the Y direction. The airtight container 20 accommodates and holds the end plates 21a, 21b, the metal electrodes 22, the dielectric electrodes 24, the fuses 40, and the spacers 42. The outer periphery of the airtight container 20 is connected to a gas inlet 27, a gas outlet 28, a cooling-water inlet 30, and a cooling-water outlet 32. The gas inlet 27 works to introduce oxygen-containing gas as a raw material into the airtight container 20 from outside. The gas outlet 28 works to discharge unreacted raw gas and ozone (O₃) to outside. The cooling-water inlet 30 is located at the bottom of the airtight container 20. The cooling-water inlet 30 introduces the cooling-water supplier 16 from outside into the outer periphery of the metal electrode 22. The cooling-water outlet 32 is located at the top of the airtight container 20. The cooling-water outlet 32 works to discharge cooling water having flowed through the outer periphery of the metal electrode 22 to outside.

The end plates 21a, 21b contain a conductive material such as stainless steel. The end plates 21a, 21b have a disk shape. The outer periphery of the end plates 21a, 21b is fixed to the airtight container 20. The end plate 21b opposes the end plate 21a in substantially parallel thereto. The end plates 21a, 21b are connected to a ground potential through the airtight container 20. The end plates 21a, 21b are provided with a plurality of circular holes 26a, 26b. The holes 26a, 26b have substantially the same shape as the end of the metal electrode 22. The holes 26a, 26b are spaced from each other at substantially equal intervals.

The metal electrodes 22 are made of the same material as the end plates 21a, 21b, and contain a conductive material such as stainless steel to exert conductivity. The metal electrodes 22 are located inside the airtight container 20. The metal electrodes 22 are arrayed at substantially equal intervals in the X direction and the Z direction with their lengths (that is, axial direction) extending in the Y direction. The metal electrodes 22 have a tubular shape having the axis in the Y direction that is parallel to the axis of the airtight container 20. One end of each metal electrode 22 is coupled to the circular hole 26a of one end plate 21a. The other end of the metal electrode 22 is coupled to the circular hole 26b of the other end plate 21b. The opposing ends of each metal electrode 22 are coupled to the end plates 21a, 21b by welding, for example. Thereby, the opposing ends of the metal electrode 22 are not closed but held by the end plates 21a, 21b and are electrically connected to the end plates 21a, 21b. The metal electrodes 22 are connected to the ground potential through the end plates 21a, 21b. Among the metal electrodes 22, the metal electrodes 22 located closest to the outer periphery form a cooling-water channel 46 between the metal electrodes 22 and the inner periphery of the airtight container 20. The cooling-water channel 46 is connected to the cooling-water inlet 30 and the cooling-water outlet 32 of the airtight container 20. The metal electrodes 22 in the middle part, other than the metal electrode 22 located on the outermost periphery, are provided with the cooling-water channel 46.

Each of the dielectric electrodes 24 is located in any of the metal electrodes 22 inside the airtight container 20 coaxially with the metal electrode. The dielectric electrode 24 includes a dielectric element 34, a conductive film 36, and a power feeding member 38.

The dielectric element 34 contains a dielectric material such as quartz glass, borosilicate glass, high silicate glass, aluminosilicate glass, and ceramic, and is thus electrically insulative. The dielectric element 34 has a tubular shape. One end of the dielectric element 34 on the end plate 21a side is open. The other end of the dielectric element 34 on the end plate 21b side is closed. Each dielectric element 34 is located in any of the metal electrodes 22. The dielectric element 34 and the metal electrode 22 are placed with a discharge gap 44 to which raw gas is supplied. The axis of the dielectric element 34 is substantially parallel to the axis of the airtight container 20 and the metal electrode 22, and the outer periphery of the dielectric element 34 opposes the inner periphery of the metal electrode 22. The opening-side end of the dielectric element 34 projects more outward than the end plate 21a.

The conductive film 36 contains a conductive material such as stainless steel, nickel, carbon, or aluminum, and has conductivity. The conductive film 36 is laminated on the inner surface of the dielectric element 34 by sputtering, thermal spraying, deposition, electroless plating, electroplating, or coating of a conductive material. Thus, the conductive film 36 has substantially the same tubular shape as the inner surface of the dielectric element 34.

The power feeding member 38 contains a conductive material such as stainless steel and has conductivity and ozone resistance. The power feeding member 38 is located inside the dielectric element 34 in the vicinity of the opening. The power feeding member 38 is electrically connected to the conductive film 36 and the fuse 40. In this manner, the power feeding member 38 is applied with an AC voltage from the high-voltage power supply 14 through the fuse 40 and applies it to the conductive film 36.

The fuse 40 is placed with the axis substantially matching the axis of the dielectric element 34. One end of the fuse 40 is electrically connected to the high-voltage power supply 14 through a high-tension insulator 14a and a lead wire 14b. The other end of the fuse 40 is electrically connected to the power feeding member 38. In the case of the dielectric element 34 being damaged due to insulation breakdown, the fuse 40 serves to interrupt an overcurrent flowing into the conductive film 36, and separate the damaged dielectric electrode 24 from the other dielectric electrodes 24, allowing the ozone generator 10 to continue to operate.

The spacer 42 is located between the metal electrode 22 and the dielectric electrode 24. The spacer 42 serves to maintain the discharge gap 44 between the metal electrode 22 and the conductive film 36 at a given interval. The spacer 42 may be a projection united with the metal electrode 22.

The high-voltage power supply 14 is connected to the power feeding member 38 through the lead wire 14b and the fuse 40. The high-voltage power supply 14 applies a high-frequency, high AC voltage to the conductive 36 through the fuse 40 and the power feeding member 38.

The cooling-water supplier 16 is a chiller or a pump, for example. The cooling-water supplier 16 is connected to the cooling-water inlet 30 of the airtight container 20, and supplies cooling water from the cooling-water inlet 30 to the channel 46 inside the airtight container 20.

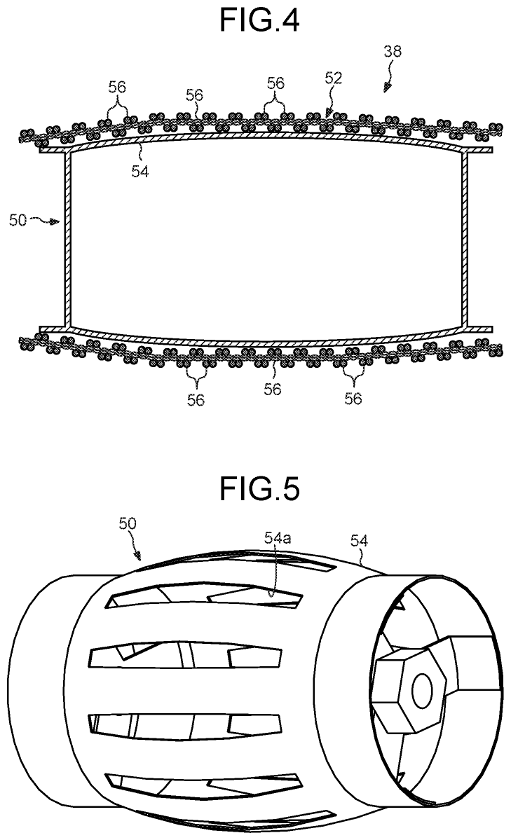

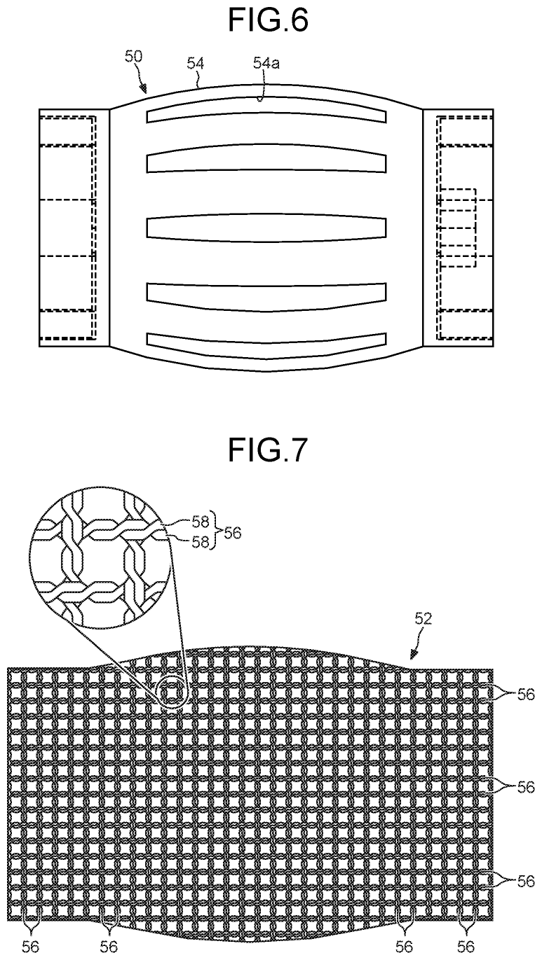

The following will describe the power feeding member 38. FIG. 3 is a side view of the power feeding member 38 according to the first embodiment. FIG. 4 is a section view of the power feeding member 38 along a IV-IV line. FIG. 5 is an overall perspective view of an elastic member 50 of the power feeding member 38. FIG. 6 is a side view of the elastic member 50. FIG. 7 is a side view of a contact member 52 of the power feeding member 38. FIG. 3 omits depicting part of the contact member 52. In FIG. 7 the circle outside the contact member 52 is an enlarged view of the circle inside the contact member 52.

As illustrated in FIG. 3 and FIG. 4, the power feeding member 38 includes the elastic member 50 and the contact member 52.

As illustrated in FIG. 3 to FIG. 6, the elastic member 50 has a tubular shape. The elastic member 50 is located in the dielectric element 34 coaxially with the dielectric element 34. The elastic member 50 contains a conductive material such as stainless steel and has conductivity and ozone resistance. One end of the elastic member 50 is connected to the fuse 40. The elastic member 50 includes, at a center, an elastic part 54 being elastically deformable. The elastic part 54 has a tubular shape larger in diameter in the center than both ends. The elastic part 54 is elastically deformable in the radial direction of the dielectric element 34. The elastic part 54 is provided with a plurality of openings 54a long along the axis of the elastic member 50. Thereby, the elastic part 54 is easily elastically deformable to press the contact member 52, located in the outer periphery, against the conductive film 36.

As illustrated in FIG. 3, FIG. 4, and FIG. 7, the contact member 52 has a tubular shape having both longitudinal ends being open. The contact member 52 is located on the outer periphery of the elastic member 50, covering substantially the entire outer periphery of the elastic member 50. The contact member 52 contains a conductive material such as stainless steel and has conductivity and ozone resistance. The contact member 52 includes a plurality of metal wires 56. The metal wires 56 are made of warps and wefts woven by stockinet, for example, arranged at substantially equal intervals. Thus, the contact member 52 is of a mesh form including the metal wires 56 arranged with substantially equal intervals along the circumference and the length of the elastic member 50, and openings arrayed in two directions with substantially equal intervals. Each of the metal wires 56 includes a plurality of (two, for example) metal fine wires 58. The metal fine wires 58 are twisted. The metal fine wires 58 have a diameter of 80 μm or larger. The contact member 52 is pressed radially outward by elastic force of the elastic member 50 to contact with and is electrically connected to the conductive film 36. In this manner, the contact member 52 electrically connects the conductive film 36 and the elastic member 50.

The following will describe the action of the ozone generator 10. The ozone generator 10 is supplied with raw gas from the gas inlet 27 while the cooling water is supplied from the cooling-water inlet 30 and flows in the cooling-water channel 46 outside the metal electrodes 22 to cool the metal electrodes 22. In this state, the high-voltage power supply 14 supplies an AC voltage between the conductive film 36 and. each metal electrode 22 through the fuse 40 and the elastic member 50 and the contact member 52 of the power feeding member 38. Thereby, the discharge gap 44 between the conductive film 36 and the metal electrode 22 is applied with a high voltage, causing silent discharge in the discharge gap 44. Ozone is generated from oxygen in the raw gas by silent discharge. The generated ozone is discharged from the gas outlet 28.

As described above, the ozone generator 10 of the first embodiment includes the power feeding member 38 including the contact member 52 of a mesh form made of the woven metal wires 56. Thereby, the ozone generator 10 can enhance its durability by improving the mechanical strength of the power feeding member 38, as compared. with the one including the contact member made of a brush, stainless wool, or metal wool, for example. Thus, the ozone generator 10 can reduce damage of the contact member 52 of the power feeding member 38 applied with a high voltage.

The ozone generator 10 includes the contact member 52 of a mesh form including the metal wires 56 arranged substantially uniformly in the circumferential direction and the longitudinal direction. Thereby, the ozone generator 10 enables the mechanical strength of the contact member 52 and the electrical contact resistance between the contact member 52 and the conductive film 36 to be uniform in the circumferential direction and the longitudinal direction. As a result, the ozone generator 10 can reduce mechanical or electrical load locally acting on the contact member 52, which further reduces damage of the contact member 52.

The ozone generator 10 is provided with the contact member 52 including the metal wires 56 made of the twisted. metal fine wires 58 of 80 μm or larger. The inventors of the present application investigated through experiment how the contact members formed of metal fine wires of 50 μm or smaller and the contact members 52 formed of the metal fine wires 58 of 80 μm or larger were damaged, when applied with the same high voltage. As a result of the experiment, it was found that the contact members 52 formed of the metal fine wires 58 of 80 μm or larger hardly suffered damage, while a large number of the contact members formed of the metal fine wires of 50 μm or smaller were damaged by heat and other factors. This is because the larger diameter of the metal fine wire 58 increases a unit surface area, resulting in inhibiting oxidization of the metal fine wires due to heat. From this result, it is understood that the contact members 52 of the embodiment can be prevented from being damaged due to heat or other factors, when applied with a high voltage.

The ozone generator 10 includes the contact member 52 including the metal wires 56 made of the twisted. metal fine wires 58. Thus, according to the ozone generator 10, the metal wires 56 can be further improved in strength, making it possible to prevent the contact member 52 from being damaged.

The ozone generator 10 includes the elastic member 50 elastically deformable in the radial direction. Thereby, according to the ozone generator 10, the elastic member 50 can press the contact member 52 located therearound onto the conductive film 36 by elastic force. As a result, the ozone generator 10 can increase the contact area and reduce electrical contact resistance between. the contact member 52 and the conductive film 36.

### Second Embodiment

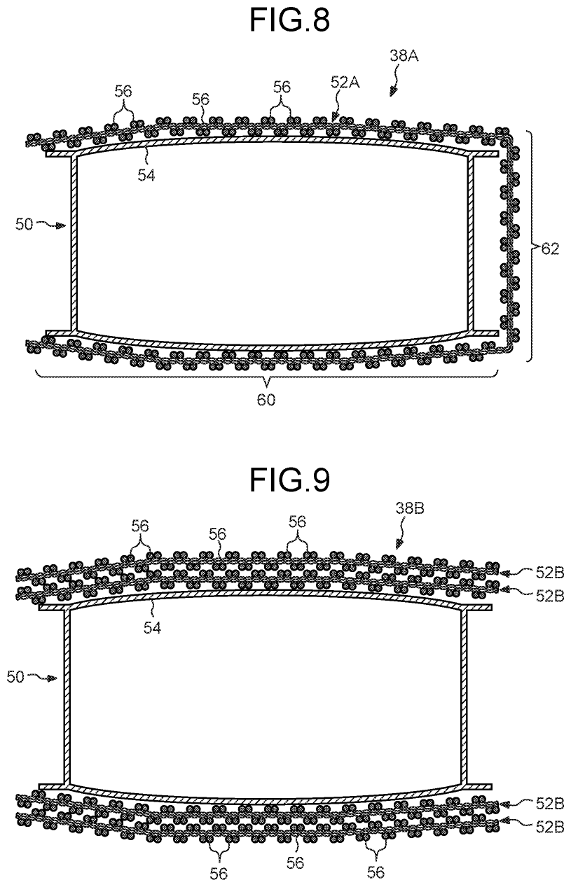

FIG. 8 is a section view of a power feeding member 38A according to a second embodiment. As illustrated in FIG. 8, the power feeding member 38A includes an elastic member 50 and a contact member 52A. The contact member 52A has a tubular shape with one side (fuse 40 side, for example) open and the other side closed. The contact member 52A includes a contact part 60 and a closed part 62.

The contact part 60 has substantially the same structure as the contact member 52 of the first embodiment. That is, the contact part 60 has a tubular shape with both open ends. The contact part 60 is located in the outer periphery of the elastic member 50. The contact part 60 is pressed by the elastic member 50 to be electrically connected to the conductive film 36.

The closed part 62 is coupled to the other opening (that is, at the closed end of the dielectric element 34) of the tubular contact member 52. The closed part 62 covers and closes the other opening of the contact member 52. As with the contact member 52 and the contact part 60, the closed part 62 is of a mesh form including woven metal wires 56 formed by twisting metal fine wires 58.

As described above, the contact member 52A of the second embodiment includes the closed part 62 that closes the other opening of the contact part 60. This makes it possible for the assembly worker or an assembling machine to easily position the contact part 60 for attaching the contact part 60 to the outer periphery of the elastic member 50.

### Third Embodiment

FIG. 9 is a section view of a power feeding member 38B according to the third embodiment. As illustrated in FIG. 9, the power feeding member 38B of the third embodiment includes an elastic member 50 and a plurality of contact members 52B.

The contact members 52B have the same structure as the contact member 52 of the first embodiment. The contact members 52B are laminated on the outer periphery of the elastic member 50.

As described above, the power feeding member 38B of the third embodiment includes the laminated contact members 52B. Thus, the contact members 52B of the power feeding member 38B can be further improved in mechanical strength. Moreover, according to the power feeding member 38B, in the case of any of the contact members 52B partially damaged, the rest of the contact members 52B can work to prevent the electric connection between the elastic member 50 and the conductive film 36 from being shut off.

Forms, numbers, arrangement, and numerical values of the elements of the first to third embodiments may be changed appropriately. The respective embodiments may be combined together when appropriate.

For example, the first to third embodiments have described the example of the metal wires 56 including two metal fine wires 58. However, the number of metal fine wires 58 may be changed when appropriate. The metal wire 56 may include one or three or more metal fine wires 58, for example.

The first to third embodiments have described the metal fine wire 58 having a diameter of 80 μm or larger by way of example. However, the wire diameter is not limited to 80 μm or larger. For example, the metal fine wire 58 may be 70 μm. or larger or 120 μm or smaller.

While certain embodiments have been described, these embodiments have been presented by way of example only, and are not intended to limit the scope of the invention. Indeed, these novel embodiments described herein may be embodied in a variety of other forms; furthermore, various omissions, substitutions and changes may be made without departing from the spirit of the invention. The accompanying claims and their equivalents are intended to cover such embodiments and the modifications thereof as would fail within the scope and spirit of the invention.

1. An ozone generator, comprising:
a metal electrode;
a tubular dielectric element spaced from the metal electrode with a discharge gap to which raw gas is supplied;
a conductive film located on an inner surface of the dielectric element; and
a power feeding member electrically connected to the conductive film, the power feeding member comprising
a contact member of a mesh form including a plurality of woven metal wires, the contact member that contacts with the conductive film.

2. The ozone generator according to claim 1, wherein the metal wires comprise a metal fine wire in diameter of 80 μm or larger.

3. The ozone generator according to claim 1, wherein
the metal wires comprise a plurality of twisted metal fine wires.

4. The ozone generator according to any one of claim 1, wherein
the contact member has a tubular shape with one side open and the other side closed.

5. The ozone generator according to claim 1, wherein
the power feeding member comprises a plurality of contact members laminated on each other.

6. The ozone generator according to claim 1, wherein
the power feeding member comprises an elastic member elastically deformable in a radial direction of the dielectric element, and
the contact member is located in an outer periphery of the elastic member.
